(19) United States
(12) Patent Application Publication
(10) Pub. No.: US 2025/0182974 A1
(43) Pub. Date: Jun. 5, 2025

(54) MULTILAYER ELECTRONIC COMPONENT

(71) Applicant: SAMSUNG ELECTRO-MECHANICS CO., LTD., Suwon-si (KR)

(72) Inventors: Si Taek PARK, Suwon-si (KR); Hyoung Uk KIM, Suwon-si (KR)

(73) Assignee: SAMSUNG ELECTRO-MECHANICS CO., LTD., Suwon-si (KR)

(21) Appl. No.: 18/944,681

(22) Filed: Nov. 12, 2024

(30) Foreign Application Priority Data
Dec. 1, 2023 (KR) 10-2023-0172712

(51) Int. Cl. H01G 4/30; H01G 4/008; H01G 4/012; H01G 4/12

(52) U.S. Cl. CPC H01G 4/30; H01G 4/008; H01G 4/012; H01G 4/1227

(57) ABSTRACT

A multilayer electronic component includes a body including a dielectric layer and internal electrodes; and external electrodes disposed on the body, wherein the dielectric layer includes a plurality of dielectric grains, and at least one of the plurality of dielectric grains has a core-shell structure including a core and a shell surrounding at least a portion of the core, wherein a percentage of an average diameter of the core based on an average thickness of the dielectric layer is 15% or more and 19% or less, and wherein the shell includes rare earth elements and tin (Sn), and an average atomic percentage of a sum of rare earth elements and tin (Sn) in the shell is 0.8 at % or more and 1.2 at % or less.

### CROSS-REFERENCE TO RELATED APPLICATION(S)

This application claims benefit of priority to Korean Patent Application No. 10-2023-0172712 filed on Dec. 1, 2023 in the Korean Intellectual Property Office, the disclosure of which is incorporated herein by reference in its entirety.

### BACKGROUND

### 1. Field

The present disclosure relates to a multilayer electronic component.

### 2. Description Of Related Art

A multilayer ceramic capacitor (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, charging or discharging electricity therein or therefrom.

Such a multilayer ceramic capacitor may be used as a component of various electronic devices, since a multilayer ceramic capacitor may have a small size and high capacitance and may be easily mounted. As various electronic devices such as a computer and a mobile device have been designed to have a smaller size and higher output, the demand for miniaturization and increased capacitance of multilayer ceramic capacitors has increased.

Generally, to implement large capacitance without increasing the volume of the MLCC, it may be advantageous to configure a dielectric layer and an internal electrode included in a MLCC. However, as a thickness of the dielectric layer deceases, a side effect of lower reliability in high temperature stress may appear. Accordingly, to simultaneously assure high capacitance and high reliability, a method to reduce reliability when reducing a thickness of a dielectric layer may be necessary.

One of important factors in reliability of a dielectric may have a structure of a core and a shell of the dielectric. Since a shell region generally has higher resistance than a core region, it may be important to control the core and shell ratio to an appropriate ratio in improving reliability of MLCC.

### SUMMARY

Some embodiments of the present disclosure is to provide a multilayer electronic component having improved dielectric constant.

Some embodiments of the present disclosure is to provide a multilayer electronic component having improved mean time to failure (MTTF) under harsh conditions.

An embodiment of the present disclosure is to prevent short circuits in a multilayer electronic component under harsh conditions.

Some embodiments of the present disclosure is to provide a multilayer electronic component having improved reliability.

According to some embodiments of the present disclosure, a multilayer electronic component includes a body including a dielectric layer and internal electrodes; and external electrodes disposed on the body, wherein the dielectric layer includes a plurality of dielectric grains, and at least one of the plurality of dielectric grains has a core-shell structure including a core and a shell surrounding at least a portion of the core, wherein a percentage of an average diameter of the core is 15% or more and 19% or less of an average thickness of the dielectric layer, and wherein the shell includes rare earth elements and tin (Sn), and an average atomic percentage of a sum of the rare earth elements and tin (Sn) in the shell is 0.8 at % or more and 1.2 at % or less with respect to a total atomic amount of the shell.

### BRIEF DESCRIPTION OF DRAWINGS

The and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is an exploded perspective diagram illustrating a lamination structure of an internal electrode according to an embodiment of the present disclosure;

FIG. 3 is a cross-sectional diagram taken along line I-I′ in FIG. 1;

FIG. 4 is a cross-sectional diagram taken along line II-II′ in FIG. 1;

FIG. 5 is an enlarged diagram illustrating region P in FIG. 3; and

FIG. 6 is an enlarged diagram illustrating a portion of region P in FIG. 5.

### DETAILED DESCRIPTION

Hereinafter, some embodiments of the present disclosure will be described as below with reference to the accompanying drawings.

These embodiments are described in sufficient detail to enable those skilled in the art to practice the present disclosure. It is to be understood that the various embodiments of the present disclosure, although different, are not necessarily mutually exclusive. For example, structures, shapes, and sizes described as examples in some embodiments in the present disclosure may be implemented in another embodiment without departing from the spirit and scope of the present disclosure. Further, modifications of positions or arrangements of elements in some embodiments may be made without departing from the spirit and scope of the present disclosure. The following detailed description is, accordingly, not to be taken in a limiting sense, and the scope of the present disclosure are defined only by appended claims, appropriately interpreted, along with the full range of equivalents to which the claims are entitled.

In the drawings, same elements will be indicated by same reference numerals. Also, redundant descriptions and detailed descriptions of known functions and elements which may unnecessarily make the gist of the present disclosure obscure will be omitted. In the accompanying drawings, some elements may be exaggerated, omitted or briefly illustrated, and the sizes of the elements do not necessarily reflect the actual sizes of these elements. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the first direction may be defined as a lamination direction or a thickness (T) direction, the second direction may be defined as a length (L) direction, and the third direction may be defined as a width (W) direction.

As used herein, the term “a main component” means occupying 50% by mass or more, 50 mol % or more of the constituent components.

### Multilayer Electronic Component

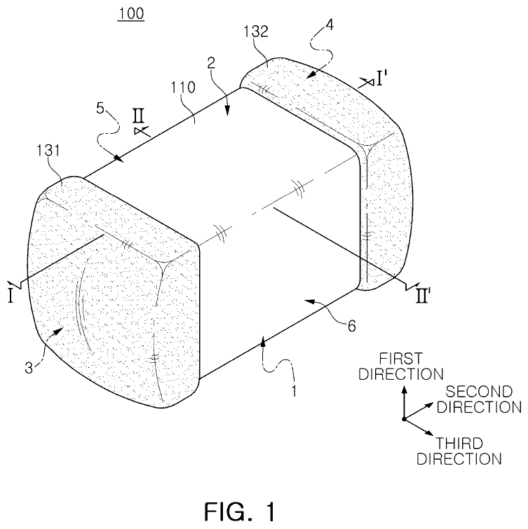

FIG. 1 is a perspective diagram illustrating a multilayer electronic component according to an embodiment.

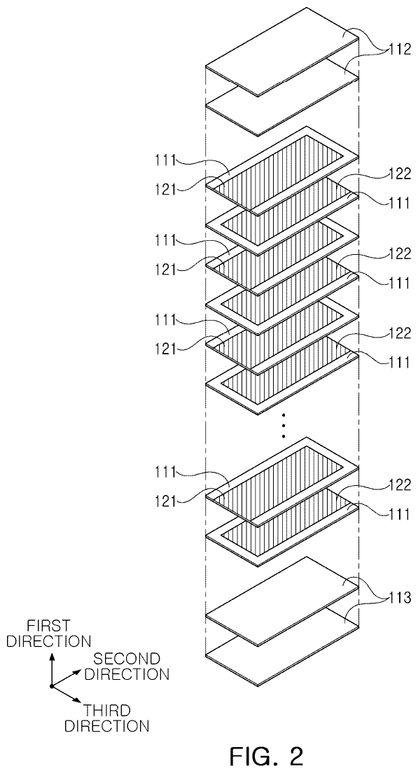

FIG. 2 is an exploded perspective diagram illustrating a lamination structure of an internal electrode according to an embodiment.

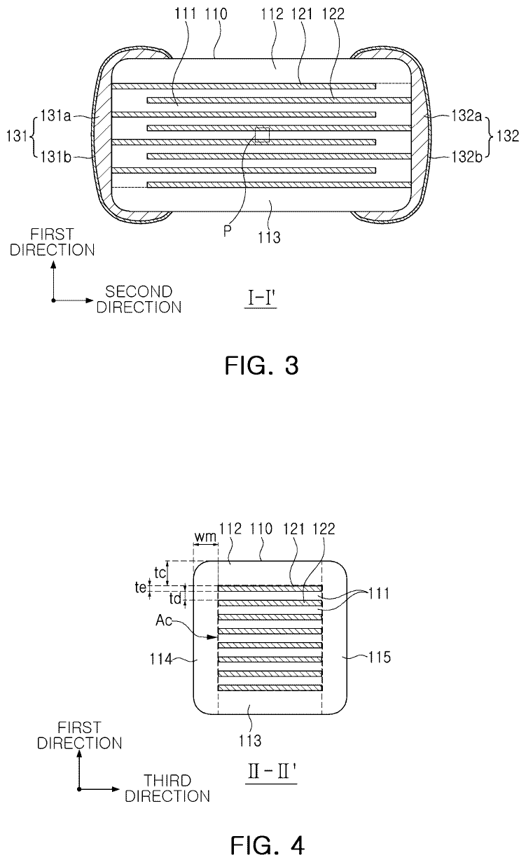

FIG. 3 is a cross-sectional diagram taken along line I-I′ in FIG. 1.

FIG. 4 is a cross-sectional diagram taken along line II-II′ in FIG. 1.

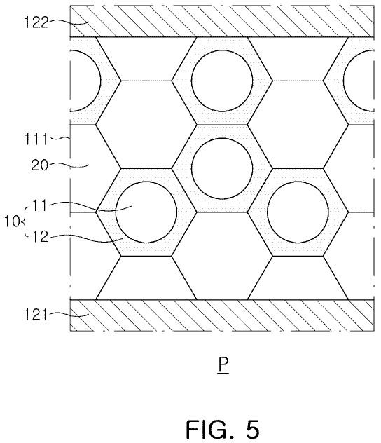

FIG. 5 is an enlarged diagram illustrating region P in FIG. 3.

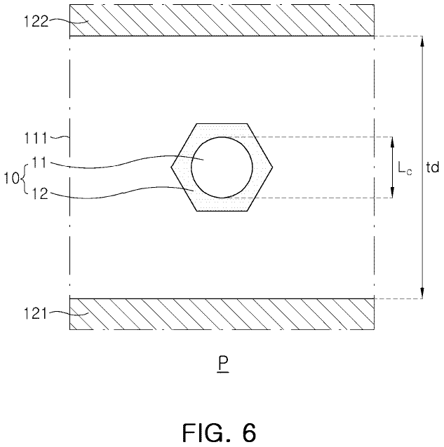

FIG. 6 is an enlarged diagram illustrating a portion of region P in FIG. 5.

Hereinafter, a multilayer electronic component according to some embodiments will be described in greater detail with reference to FIGS. 1 to 6. A multilayer ceramic capacitor will be described as an example of a multilayer electronic component, but an embodiment thereof is not limited thereto, and the multilayer ceramic capacitor may be applied to various multilayer electronic components, such as an inductor, a piezoelectric element, a varistor, or a thermistor.

A multilayer electronic component 100 according to some embodiments may include a body 110 including a dielectric layer 111 and internal electrode 121 and 122; and external electrodes 131 and 132 disposed on the body 110, wherein the dielectric layer 111 may include a plurality of dielectric grains 10 and 20, and at least one of the plurality of dielectric grains 10 and 20 may have a core-shell structure 10 including a core 11 and a shell 12 surrounding at least a portion of the core 11, wherein a percentage of an average diameter of the core 11 is 15% or more and 19% or less of an average thickness of the dielectric layer 111, and wherein the shell 12 includes rare earth elements and tin (Sn), and an average atomic percentage of a sum of the rare earth elements and tin (Sn) in the shell 12 is 0.8 at % or more and 1.2 at % or less with respect to a total atomic amount of the shell.

In the body 110, the dielectric layers 111 and the internal electrodes 121 and 122 may be alternately laminated.

More specifically, the body 110 may include a capacitance forming portion Ac disposed in the body 110 and forming capacitance including the first internal electrode 121 and the second internal electrode 122 alternately disposed to face each other with the dielectric layer 111 interposed therebetween.

The shape of the body 110 may not be limited to any particular shape, but as illustrated, the body 110 may have a hexahedral shape or a shape similar to a hexahedral shape. Due to reduction of ceramic powder included in the body 110 during a firing process, the body 110 may not have an exactly hexahedral shape formed by linear lines but may have a substantially hexahedral shape.

The body 110 may have the first and second surfaces 1 and 2 opposing each other in the first direction, the third and fourth surfaces 3 and 4 connected to the first and second surfaces 1 and 2 and opposing in the second direction, and the fifth and sixth surfaces 5 and 6 connected to the first to fourth surfaces 1, 2, 3, and 4 and opposing each other in the third direction.

The plurality of dielectric layers 111 forming the body 110 may be in a fired state, and a boundary between the adjacent dielectric layers 111 may be integrated with each other such that the boundary may not be distinct without using a scanning electron microscope (SEM).

The raw material forming the dielectric layer 111 is not limited as long as sufficient capacitance may be obtained therewith, and generally, a perovskite (ABO3) material may be used, and for example, a barium titanate material, a lead composite perovskite material, or a strontium titanate material may be used. A barium titanate material may include BaTiO₃ ceramic particles, and an example of the ceramic powder may include at least one selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1) in which Ca (calcium) and Zr (zirconium) are partially dissolved.

Also, as a raw material for forming the dielectric layer 111, various ceramic additives, organic solvents, binders, and dispersants may be added to particles such as barium titanate (BaTiO₃) depending on the purpose of the embodiments. For example, the additive may include rare earth elements and tin (Sn), and the rare earth elements may include at least one of dysprosium (Dy) or terbium (Tb), but an embodiment thereof is not limited thereto.

Since the dielectric layer 111 may be formed using a dielectric material such as barium titanate (BaTiO₃), the dielectric layer 111 may include a dielectric microstructure after firing. The dielectric microstructure may include a plurality of grains, a grain boundary disposed between the adjacent grains, and a triple point at which three or more of the grain boundaries are in contact with each other, and a plurality of triple points may be included.

Here, at least one of the plurality of dielectric grains may have the core-shell structure 10 including the core 11, and the shell 12 surrounding at least a portion of the core 11. In other words, the plurality of dielectric grains 10 and 20 may include the dielectric grains 10 having a core-shell structure and the dielectric grains 20 without a core-shell structure, which will be described in greater detail later.

A thickness td of the dielectric layer 111 may not be limited to any particular example.

To more easily achieve miniaturization and high capacity of the multilayer electronic component, the thickness td of the dielectric layer 111 may be 0.8 μm or less.

Here, the thickness td of the dielectric layer 111 may refer to the thickness td of the dielectric layer 111 disposed between the first and second internal electrodes 121 and 122.

The thickness td of the dielectric layer 111 may refer to the size, in the first direction, of the dielectric layer 111. Also, the thickness td of the dielectric layer 111 may refer to the average thickness td of the dielectric layer 111 and may refer to the average size, in the first direction, of the dielectric layer 111.

The average size, in the first direction, of the dielectric layer 111 may be measured by scanning a cross-section in the first and second directions of the body 110 using a scanning electron microscope (SEM) with a magnification of 10,000. More specifically, the average size, in the first direction, of the dielectric layer 111 may indicate the average value calculated by measuring the sizes, in the first direction, of the dielectric layer 111 at 10 points at an equal distance in the second direction in the scanned image. The 10 points at an equal distance may be specified in the capacitance formation portion Ac. Also, by extending the measurement of the average value to 10 dielectric layers 111, the average size, in the first direction, of the dielectric layer 111 may be further generalized.

The internal electrodes 121 and 122 may be laminated alternately with the dielectric layer 111.

The internal electrodes 121 and 122 may include a first internal electrode 121 and a second internal electrode 122, the first and second internal electrodes 121 and 122 may be alternately disposed to face each other with the dielectric layer 111 included in the body 110 interposed therebetween, and may be exposed to the third and fourth surfaces 3 and 4 of the body 110, respectively.

More specifically, the first internal electrode 121 may be spaced apart from the fourth surface 4 and may be exposed through the third surface 3, and the second internal electrode 122 may be spaced apart from the third surface 3 and may be exposed through the fourth surface 4. The first external electrode 131 may be disposed on the third surface 3 of the body 110 and may be connected to the first internal electrode 121, and the second external electrode 132 may be disposed on the fourth surface 4 of the body 110 and may be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. In this case, the first and second internal electrodes 121 and 122 may be electrically separated from each other by the dielectric layer 111 disposed therebetween.

The body 110 may be formed by alternately laminating ceramic green sheets on which the first internal electrodes 121 are printed and ceramic green sheets on which the second internal electrodes 122 are printed, and firing the sheets.

The material for forming the internal electrodes 121 and 122 is not limited to any particular example, and a material having excellent electrical conductivity may be used. For example, the internal electrodes 121 and 122 may include one or more selected from the group consisting of nickel (Ni), copper (Cu), palladium (Pd), silver (Ag), gold (Au), platinum (Pt), tin (Sn), tungsten (W), titanium (Ti), and alloys thereof.

Also, the internal electrodes 121 and 122 may be formed by printing conductive paste for internal electrodes including one or more selected from the group consisting of nickel (Ni), copper (Cu), palladium (Pd), silver (Ag), gold (Au), platinum (Pt), tin (Sn), tungsten (W), titanium (Ti), and alloys thereof on a ceramic green sheet. A screen printing method or a gravure printing method may be used as a method of printing the conductive paste for internal electrodes, but an embodiment thereof is not limited thereto.

The thickness te of the internal electrodes 121 and 122 may not be limited to any particular example.

To ensure miniaturization and high capacitance of the multilayer electronic component 100, the thickness of the internal electrodes 121 and 122 may be 1.0 μm or less, preferably 0.6 μm or less, and more preferably 0.4 μm or less.

Also, the thickness te of the internal electrodes 121 and 122 may indicate the size of the internal electrodes 121 and 122 in the first direction. Also, the thickness te of internal electrodes 121 and 122 may indicate the average thickness te of the internal electrodes 121 and 122, and may indicate the average size of the internal electrodes 121 and 122 in the first direction.

The average size, in the first direction, of the internal electrodes 121 and 122 may be measured by scanning a cross-section of the body 110 using a scanning electron microscope (SEM) with a magnification of 10,000×. More specifically, an average value may be measured from the sizes, in the first direction, of the internal electrode at 10 points at an equal distance in the second direction in the scanned image. The 10 points at an equal distance may be designated in the capacitance formation portion Ac. Also, by extending the measurement of the average value to 10 internal electrodes, the average size of the internal electrodes 121 and 122 may be further generalized.

The body 110 may include first and second cover portions 112 and 113 disposed on both end-surfaces of the capacitance forming portion Ac in the first direction.

Specifically, the body 110 may include a first cover portion 112 disposed on one surface in the first direction of the capacitance formation portion Ac and a second cover portion 113 disposed on the other surface in the first direction of the capacitance formation portion Ac. More specifically, the body 110 may include the first cover portion 112 disposed in the upper portion in the first direction of the capacitance formation portion Ac and the second cover portions 113 disposed in the lower portion in the first direction of the capacitance formation portion Ac.

The first cover portion 112 and the second cover portion 113 may be formed by laminating a single dielectric layer 111 or two or more dielectric layers 111 on the upper and lower surfaces of the capacitance forming portion Ac in the first direction, and may prevent damages to the internal electrodes 121 and 122 due to physical or chemical stress.

The first cover portion 112 and the second cover portion 113 may not include the internal electrodes 121 and 122 and may include the same material as that of the dielectric layer 111. That is, the first cover portion 112 and the second cover portion 113 may include a ceramic material, for example, a barium titanate (BaTiO3) ceramic material.

The thickness tc of the cover portion 112 and 113 may not be limited to any particular example.

However, to easily implement miniaturization and high capacitance of multilayer electronic component, the thickness tc of the cover portions 112 and 113 may be 100 μm or less, preferably 30 μm or less. More preferably, the thickness may be 20 μm or less in an ultra-small product.

Here, the thickness tc of the cover portion 112 or 113 may refer to the size, in the first direction, of the cover portion 112 or 113. Also, the thickness tc of each of the cover portions 112 and 113 may refer to the average thickness te of the cover portions 112 and 113, and may refer to the average size, in the first direction, of the cover portions 112 and 113.

The average size of each of the first and second cover portions 112 and 113 may be measured by scanning a cross-section in the first and second directions of the body 110 using a scanning electron microscope (SEM) at a magnification of 10,000. More specifically, the average size may indicate the average value calculated by measuring the sizes, in the first direction, at 10 points at an equal distance in the second direction in the scanned image of the cover portion.

Also, the average size, in the first direction, of the cover portion measured by the above method may be substantially the same as the average size, in the first direction, of the cover portion in the cross-section in the first and third directions of the body 110.

The first and second side margin portions 114 and 115 may be disposed on both end-surfaces in the third direction of the body 110.

More specifically, the side margin portions 114 and 115 may include a first side margin portion 114 disposed on the fifth surface 5 and a second side margin portion 115 disposed on the sixth surface 6 of the body 110. That is, the side margin portions 114 and 115 may be disposed on both end-surfaces of the body 110 in the third direction.

As illustrated, the side margin portions 114 and 115 may refer to a region between both end-surfaces in the third direction of the first and second internal electrodes 121 and 122 and the boundary surface of the body 110 with respect to the cross-section in the first and third directions of the body 110.

The first and second side margin portions 114 and 115 may prevent damages to the internal electrodes 121 and 122 due to physical or chemical stress.

The first and second side margin portions 114 and 115 may be formed by forming the internal electrodes 121 and 122 on a ceramic green sheet by applying a conductive paste other than the region in which the first and second side margin portions 114 and 115 are formed, cutting the laminated internal electrodes 121 and 122 to expose the fifth and sixth surfaces 5 and 6 of the body 110 to prevent a step difference caused by the internal electrodes 121 and 122, and laminating a single dielectric layer 111 or two or more dielectric layers 111 in the third direction on both end-surfaces in the third direction of the capacitance forming portion Ac.

The first side margin portion 114 and the second side margin portion 115 may not include the internal electrodes 121 and 122 and may include the same material as that of the dielectric layer 111. That is, the first side margin portion 114 and the second side margin portion 115 may include a ceramic material, for example, a barium titanate (BaTiO₃) ceramic material.

The width wm of the first and second side margin portions 114 and 115 may not be limited to any particular example.

However, to easily implement miniaturization and high capacitance of the multilayer electronic component 100, the width wm of each of the side margin portions 114 and 115 may be 100 μm or less, preferably 30 μm or less, and may be more preferably 20 μm or less in an ultra-small product.

Here, the width wm of the side margin portions 114 and 115 may refer to the size of the side margin portions 114 and 115 in the third direction. Also, the width wm of the side margin portions 114 and 115 may refer to the average width wm of the side margin portions 114 and 115, and the average size in the third direction of the side margin portions 114 and 115.

The average size in the third direction of the side margin portion 114 and 115 may be measured by scanning a cross-section in the first and third directions of the body 110 using a scanning electron microscope (SEM) at a magnification of 10,000. More specifically, the average size may be an average value measured from the sizes in the third direction at 10 points at an equal distance in the first direction in the scanned image of one of the side margin portions.

In some embodiments, the ceramic electronic component 100 may have two external electrodes 131 and 132, but the number of the external electrodes 131 and 132 or the shape thereof may be varied depending on the forms of the internal electrode 121 and 122 or other purposes.

The external electrodes 131 and 132 may be disposed on the body 110 and may be connected to the internal electrodes 121 and 122.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and may be connected to the second internal electrode 122.

Also, the first and second external electrodes 131 and 132 may extend and be disposed on portions of the first and second surfaces 1 and 2 of the body 110, or may extend and be disposed on a portion of the fifth and sixth surfaces 5 and 6 of the body 110. That is, the first external electrode 131 may be disposed on a portion of the first, second, fifth, and sixth surfaces 1, 2, 5, and 6 of the body 110, and the third surface 3 of the body 110, and the second external electrode 132 may be disposed on a portion of the first, second, fifth, and sixth surfaces 1, 2, 5, and 6 of the body 110, and the third surface 3 of the body 110.

The first and second external electrodes 131 and 132 may be formed of any material having electrical conductivity, such as metal, and a specific material may be determined in consideration of electrical properties and structural stability, and the external electrodes 131 and 132 may have a multilayer structure.

For example, the first and second external electrodes 131 and 132 may include electrode layers 131a and 132a disposed on the body 110 and plating layers 131b and 132b disposed on the electrode layer, respectively.

For a more specific example of the electrode layer, the electrode layers 131a and 132a may be fired electrodes including conductive metal and glass, or may be resin-based electrodes including conductive metal and resin.

The electrode layers 131a and 132a may be formed by forming a fired electrode and a resin-based electrode in order on the body 110.

The electrode layers 131a and 132a may be formed by transferring a sheet including a conductive metal to the body 110, or by transferring a sheet including a conductive metal to the fired electrode.

The conductive metal used in the electrode layers 131a and 132a is not limited to any particular example as long as the material may be electrically connected to the internal electrodes 121 and 122 to form electrostatic capacitance, may include, for example, one or more selected from the group consisting of nickel (Ni), copper (Cu), palladium (Pd), silver (Ag), gold (Au), platinum (Pt), tin (Sn), tungsten (W), titanium (Ti) and alloys thereof. The electrode layers 131a and 132a may be formed by applying a conductive paste prepared by adding a glass frit to the conductive metal particles and firing.

The plating layers 131b and 132b may improve mounting properties.

The types of plating layers 131b and 132b are not limited to any particular example, and may be plating layers 131b and 132b including one or more selected from the group consisting of nickel (Ni), tin (Sn), silver (Ag), palladium (Pd) and alloys thereof, or a plurality of plating layers 131b and 132b may be formed.

For a more specific example of the plating layers 131b and 132b, the plating layers 131b and 132b may be Ni plating layers or Sn plating layers, and the Ni plating layers and the Sn plating layers may be formed in order on the electrode layers 131a and 132a, and the Sn plating layers, Ni plating layers and Sn plating layers may be formed in order. Also, the plating layers 131b and 132b may include a plurality of Ni plating layers and/or a plurality of Sn plating layers.

The size of the multilayer electronic component 100 may not be limited to any particular example.

However, to implement both miniaturization and high capacitance, the number of laminates may need to be increased by reducing the thickness of the dielectric layer and the internal electrode, such that the effect described in the embodiments may be noticeable in the multilayer electronic component 100 having a size 0603 of (length×width: 0.6 mm×0.3 mm) or less.

Hereinafter, the multilayer electronic component 100 according to some embodiments of the present disclosure will be described in greater detail.

In some embodiments, in the multilayer electronic component 100, the dielectric layer 111 may include a plurality of dielectric grains 10 and 20, and at least one of the plurality of dielectric grains 10 and 20 may include a core 11, and a shell 12 surrounding at least a portion of the core 11, and a percentage of an average diameter Lc of the core 11 may be 15% or more and 19% or less of the average thickness td of the dielectric layer 111. In this case, the shell 12 may include rare earth elements and tin (Sn), and the average atomic percentage of a sum of the rare earth elements and tin (Sn) in the shell 12 may be 0.8 at % or more and 1.2 at % or less with respect to a total atomic amount of the shell.

When the average diameter L_{C} of the core 11 satisfies 15% or more and 19% or less of the average thickness td of dielectric layer 111, and the average atomic percentage of the sum of the rare earth elements and tin (Sn) in the shell 12 satisfies 0.8 at % or more and 1.2 at % or less with respect to a total atomic amount of the shell, dielectric constant and mean time to failure (MTTF) in harsh conditions may improve and shorts may be prevented, such that reliability may improve.

In some embodiments, as an example of a more specific method of measuring the content of elements included in each component of the multilayer electronic component 100, as for a destruction method, components may be analyzed using energy dispersive X-ray spectroscopy (EDS) mode of a scanning electron microscope (SEM), EDS mode of a transmission electron microscope (TEM), or scanning transmission electron microscope (TEM) EDS mode in (STEM). First, a thinly sliced analysis sample using a focused ion beam (FIB) device in the region to be measured may be prepared. Thereafter, the damaged layer on the surface of the thinned sample may be removed using xenon (Xe) or argon (Ar) ion milling, and thereafter, qualitative/quantitative analysis may be performed by mapping each component to be measured in the image obtained using SEM-EDS, TEM-EDS, or STEM-EDS. In this case, the qualitative/quantitative analysis graph of each component may be represented in terms of mass percentage (wt %), atomic percentage (at %), or moles percentage (mol %) of each element. In this case, the graph may be represented by converting the number of moles of a specific component to the number of moles of another specific component.

As another method, the chip may be pulverized and the region to be measured may be selected, and components of the portion including the selected dielectric microstructure may be analyzed using devices such as inductively coupled plasma spectrometry (ICP-OES) and inductively coupled plasma mass spectrometry (ICP-MS) devices.

Also, in some embodiments, the atomic percentage of a specific component in a region may refer to the average atomic percentage of the specific component in one region, and may indicate the average value of the atomic percentage of a specific component at a plurality of points measured in EDS. For example, the atomic percentage of tin (Sn) in the core may refer to the average atomic percentage of tin (Sn) in the core region, and the atomic percentage of tin (Sn) in the shell may indicate the average atomic percentage of tin (Sn) in the shell region.

In some embodiments, to distinguish the core 11 and the shell 12, for example, when the components are observed using SEM-EDS, TEM-EDS, or STEM-EDS mode in the cross-section in the first and second direction in the center in the third direction of the body 110 including the dielectric layer 111, a region of the cross-section of the dielectric layer 111 having a content of rare earth elements of 0 at % or more and less than 0.2 at % may be defined as the core 11, and a region having a content of rare earth elements of 0.2 at % or more may be defined as the shell 12.

The condition of the percentage of the average diameter L_{C} of the core 11 based on the average thickness td of the dielectric layer 111 will be described in greater detail with reference to FIGS. 5 and 6, and the average thickness td of the dielectric layer 111 may indicate the average size td in the first direction of the dielectric layer 111 including 10 dielectric grains of the core-shell structure, and the average diameter L_{C} of the core 11 may indicate the size in the first direction of a linear line passing through the center of the core 11 of the dielectric grains 10 of the core-shell structure included in the dielectric layer 111. In this case, when it is difficult to measure the size of the first direction of the linear line passing through the center of core 11, by calculating the area of core 11 and converting the value to a virtual circle, and the diameter of the virtual circle may be defined as the average diameter L_{C} of the core 11, but an embodiment thereof is not limited thereto.

When the percentage of the average diameter L_{C} of the core 11 based on the average thickness td of dielectric layer 111 is less than 15%, reliability in harsh conditions may not be excellent, and when the percentage of the average diameter L_{C} of the core 11 is more than 19% of the average thickness td of the dielectric layer 111, reliability under harsh conditions may not be excellent, and shorts may occur easily when voltage is applied.

Here, when the average thickness td of dielectric layer 111 is 0.8 μm or less and the average diameter L_{C} of the core 11 is 70 nm or more and 120 nm, the effect of improving dielectric constant and mean time to failure (MTTF) under harsh conditions and addressing shorts may be significant.

A lower limit of the average thickness td of the dielectric layer 111 is not limited to any particular example, and may preferably be 0.3 μm or more, and more preferably 0.4 μm or more.

When the average thickness td of the dielectric layer 111 is more than 0.8 μm, the dielectric constant may decrease or reliability under harsh conditions may decrease, and when the average thickness td of the dielectric layer 111 is less than 0.3 μm, the dielectric layer 111 may have an extremely reduced thickness such that insulation breakdown voltage (BDV) may decrease.

When the average diameter L_{C} of the core 11 is less than 70 nm, the dielectric constant may decrease, and when the average diameter L_{C} of core 11 is more than 120 nm, reliability under harsh conditions may decrease.

When the average atomic percentage of the sum of the rare earth elements and tin (Sn) in the shell 12 is less than 0.8 at % with respect to a total atomic amount of the shell, reliability under harsh conditions may be reduced, and when the average atomic percentage of the sum of the rare earth elements and tin (Sn) in the shell 12 exceeds 1.2 at % with respect to a total atomic amount of the shell, the dielectric constant may deteriorate.

The rare earth elements of the shell 12 are not limited to any particular example, and may include at least one of dysprosium (Dy) or terbium (Tb), and may preferably be one of dysprosium (Dy) or terbium (Tb), more preferably may be dysprosium (Dy).

The average atomic percentage of the rare earth elements of the shell 12 may be 0.2 at % or more and 0.7 at % or less, and the average atomic percentage of tin (Sn) of the shell 12 may be 0.2 at % or more and 1.0 at % or less.

When the average atomic percentage of the rare earth elements of the shell 12 is less than 0.2 at %, it may not be easy to measure rare earth elements, or it may be difficult to distinguish rare earth elements from the core 11, and reliability may be reduced, and when the average atomic percentage of the rare earth elements exceeds 0.7 at %, insulation resistance (IR) or breakdown voltage (BDV) may decrease or reliability may decrease due to decreased dispersibility.

When the average atomic percentage of tin (Sn) in the shell 12 is less than 0.2 at % with respect to a total atomic amount of the shell, reliability may be reduced due to a decrease in grain boundary resistance, and when the average atomic percentage of tin (Sn) in the shell 12 exceeds 1.0 at %, growth of dielectric grains may be prevented such that the dielectric constant may decrease.

The average atomic percentage of the rare earth elements of the core 11 may be 0 at % or more and less than 0.2 at % with respect to a total atomic amount of the core, and the sum of the average atomic percentage of rare earth elements of the core 11 and the average atomic percentage of tin (Sn) of the core 11 may be 0 at % or more and less than 0.4 at %.

When the average atomic percentage of the rare earth elements of the core 11 is 0.2 at % or more with respect to a total atomic amount of the core, it may not be easy to distinguish from the shell 12 or the dielectric constant may decrease, and the average atomic percentage of rare earth elements of the core 11 is 0.2 at % or more with respect to a total atomic amount of the core, the dielectric constant may decrease, and when the average atomic percentage of the sum of the rare earth elements and tin (Sn) in the core 11 is 0.4 at % or more with respect to a total atomic amount of the core, the dielectric constant may decrease or reliability may decrease.

Hereinafter, the embodiments will be described in greater detail, but it is help understanding of the present disclosure and the scope of the present disclosure is not limited thereto.

### Embodiment

In the description below, test examples according to the average diameter L_{C} of the core and the average atomic percentage of rare earth elements of the shell and the average atomic percentage of tin (Sn) of the shell based on the average thickness td of the dielectric layer were manufactured as 10,000 samples each having a size of 0603 (length×width: 0.6 mm×0.3 mm) or less than, dielectric constant, mean time to failure (MTTF), and short circuit rate under harsh conditions were measured, and listed in [Table 1] to [Table 3].

L_{C} (nm) may indicate the average diameter of the core of the dielectric grains of the core-shell structure, an image of the cross-section of the dielectric layer was obtained by mapping the components of dysprosium (Dy) and tin (Sn) in EDS mode of a transmission electron microscope (TEM), the region having an atomic percentage of dysprosium (Dy) of less than 0.2 at % was defined as the core, and the size (or length) of the linear line in the first direction passing through the center of the core, wherein unit is nanometer (nm).

Dy+Sn(at %) was the sum of the average atomic percentage of dysprosium (Dy) of the shell and the average atomic percentage of tin (Sn) of the shell in the dielectric grains of the core-shell structure in which the average diameter L_{C} of the core was measured, and the unit is mole (mol). Here, the average atomic percentage of dysprosium (Dy) and tin (Sn) in the shell was the average value of the average atomic percentage of dysprosium (Dy) and tin (Sn) in the shell.

Td (nm) was the average thickness (or the average size in the first direction) of the dielectric layer including dielectric grains of the core-shell structure measured by measuring the average diameter L_{C} of the core, and the unit is nanometer (nm).

L_{C}/td (%) was the ratio of the values of L_{C} and td represented in a percentage.

The dielectric constant was measured using an LCR meter. When the dielectric constant was 3300 or more, the sample was evaluated as excellent, and when the dielectric constant was less than 3300, the sample was evaluated as poor.

MTTF (hrs) was an average value until the time when resistance of the samples decreased and resistance measurement was not available when the applied voltage per unit thickness of the dielectric layer was 22.91 V/μm at a temperature of 125° C. for 40 samples for each example in the highly accelerated life test (HALT), and the unit is time (hrs). When the MTTF was more than 70 hours, the sample was evaluated as excellent, and when the MTTF was less than 70 hours, the sample was evaluated as poor.

The short circuit rate (%) was the number of chips among 100 samples in which the target capacitance or dielectric loss (dissipation factor, DF) was not implemented, represented in percentage, When the short circuit rate was less than 10%, the sample was evaluated as excellent, and when the short circuit rate was 10% or more, the sample was evaluated as poor.

As for (properties) evaluation, when the entirety of the conditions of dielectric constant of 3300 or more. MTTF of 70 hours or more, and short circuit rate of less than 10% were satisfied, the sample was denoted [symbol] , and when even one of these conditions was not satisfied. the sample was denoted [symbol] .

TABLE 1

| | | | | | Di- | | Short | |
|---|---|---|---|---|---|---|---|---|
| Sample | L_{C} | Dy + Sn | td | L_{C}/td | electric | MTTF | rate | Eval- |
| No. | (nm) | (at %) | (nm) | (%) | constant | (hrs) | (%) | uation |
| #1 | 70 | 0.4 | 400 | 17.5% | 3611 | 35 | 2% | X |
| #2 | 70 | 0.4 | 450 | 15.6% | 3610 | 39 | 2% | X |
| #3 | 70 | 0.4 | 550 | 12.7% | 3625 | 48 | 0% | X |
| #4 | 70 | 0.4 | 650 | 10.8% | 3605 | 49 | 0% | X |
| #5 | 70 | 0.4 | 950 | 10.5% | 3607 | 38 | 0% | X |
| #6 | 70 | 0.8 | 400 | 17.5% | 3538 | 76 | 2% | O |
| #7 | 70 | 0.8 | 450 | 15.6% | 3522 | 83 | 1% | O |
| #8 | 70 | 0.8 | 550 | 12.7% | 3530 | 61 | 0% | X |
| #9 | 70 | 0.8 | 650 | 10.8% | 3530 | 41 | 0% | X |
| #10 | 70 | 0.8 | 750 | 16.0% | 3523 | 78 | 0% | O |
| #11 | 70 | 0.8 | 1150 | 10.4% | 3530 | 41 | 0% | X |
| #12 | 70 | 1.2 | 400 | 17.5% | 3392 | 76 | 1% | O |
| #13 | 70 | 1.2 | 450 | 15.6% | 3395 | 81 | 1% | 0 |
| #14 | 70 | 1.2 | 550 | 12.7% | 3400 | 60 | 0% | X |
| #15 | 70 | 1.2 | 650 | 10.8% | 3403 | 63 | 0% | X |
| #16 | 70 | 1.2 | 950 | 12.6% | 3402 | 55 | 0% | X |
| #17 | 70 | 1.6 | 400 | 17.5% | 2203 | 75 | 2% | X |
| #18 | 70 | 1.6 | 450 | 15.6% | 2186 | 71 | 1% | X |
| #19 | 70 | 1.6 | 550 | 12.7% | 2197 | 59 | 0% | X |
| #20 | 70 | 1.6 | 650 | 10.8% | 2209 | 91 | 0% | X |
| #21 | 70 | 1.6 | 950 | 12.6% | 2220 | 58 | 0% | X |

TABLE 2

| | | | | | Di- | | | |
|---|---|---|---|---|---|---|---|---|
| Sample | L_{C} | Dy + Sn | td | L_{C}/td | electric | MTTF | Short | Eval- |
| No. | (nm) | (at %) | (nm) | (%) | constant | (hrs) | (%) | uation |
| #22 | 100 | 0.4 | 400 | 25.0% | 3600 | 32 | 31% | X |
| #23 | 100 | 0.4 | 450 | 22.2% | 3601 | 31 | 25% | X |
| #24 | 100 | 0.4 | 550 | 18.2% | 3598 | 36 | 13% | X |
| #25 | 100 | 0.4 | 650 | 15.4% | 3589 | 40 | 1% | X |
| #26 | 100 | 0.4 | 950 | 12.6% | 3620 | 40 | 0% | X |
| #27 | 100 | 0.8 | 400 | 25.0% | 3533 | 51 | 36% | X |
| #28 | 100 | 0.8 | 450 | 22.2% | 3519 | 61 | 21% | X |
| #29 | 100 | 0.8 | 550 | 18.2% | 3540 | 87 | 6% | O |
| #30 | 100 | 0.8 | 650 | 15.4% | 3534 | 90 | 1% | O |
| #31 | 100 | 0.8 | 950 | 10.5% | 3533 | 39 | 0% | X |
| #32 | 100 | 1.2 | 400 | 25.0% | 3430 | 50 | 35% | X |
| #33 | 100 | 1.2 | 450 | 22.2% | 3435 | 53 | 21% | X |
| #34 | 100 | 1.2 | 550 | 18.2% | 3433 | 70 | 4% | O |
| #35 | 100 | 1.2 | 650 | 15.4% | 3425 | 81 | 2% | O |
| #36 | 100 | 1.2 | 750 | 16.0% | 3430 | 82 | 0% | O |
| #37 | 100 | 1.2 | 1150 | 10.4% | 3431 | 59 | 0% | X |
| #38 | 100 | 1.6 | 400 | 25.0% | 2200 | 52 | 33% | X |
| #39 | 100 | 1.6 | 450 | 22.2% | 2213 | 53 | 22% | X |
| #40 | 100 | 1.6 | 550 | 18.2% | 2195 | 78 | 12% | X |
| #41 | 100 | 1.6 | 650 | 15.4% | 2189 | 88 | 2% | X |
| #42 | 100 | 1.6 | 750 | 16.0% | 2207 | 83 | 0% | X |
| #43 | 100 | 1.6 | 1150 | 10.4% | 2209 | 61 | 0% | X |

TABLE 3

| Sam- | | | | | Di- | | Short | |
|---|---|---|---|---|---|---|---|---|
| ple | L_{C} | Dy + Sn | | L_{C}/td | electric | MTTF | rate | Eval- |
| No. | (nm) | (at %) | td (nm) | (%) | constant | (hrs) | (%) | uation |
| #44 | 120 | 0.4 | 400 | 30.0% | 3620 | 36 | 48% | X |
| #45 | 120 | 0.4 | 450 | 26.7% | 3613 | 32 | 33% | X |
| #46 | 120 | 0.4 | 550 | 21.8% | 3615 | 44 | 21% | X |
| #47 | 120 | 0.4 | 650 | 18.5% | 3617 | 38 | 7% | X |
| #48 | 120 | 0.4 | 750 | 16.0% | 3621 | 31 | 1% | X |
| #49 | 120 | 0.4 | 1150 | 10.4% | 3599 | 41 | 0% | X |
| #50 | 120 | 0.8 | 400 | 30.0% | 3544 | 42 | 51% | X |
| #51 | 120 | 0.8 | 450 | 26.7% | 3528 | 61 | 38% | X |
| #52 | 120 | 0.8 | 550 | 21.8% | 3541 | 56 | 20% | X |
| #53 | 120 | 0.8 | 650 | 18.5% | 3523 | 86 | 7% | O |
| #54 | 120 | 0.8 | 950 | 12.6% | 3528 | 50 | 0% | X |
| #55 | 120 | 1.2 | 400 | 30.0% | 3419 | 51 | 50% | X |
| #56 | 120 | 1.2 | 450 | 26.7% | 3421 | 53 | 41% | X |
| #57 | 120 | 1.2 | 550 | 21.8% | 3420 | 57 | 19% | X |
| #58 | 120 | 1.2 | 650 | 18.5% | 3433 | 77 | 4% | O |
| #59 | 120 | 1.2 | 950 | 10.5% | 3428 | 55 | 0% | X |
| #60 | 120 | 1.6 | 400 | 30.0% | 2199 | 60 | 50% | X |
| #61 | 120 | 1.6 | 450 | 26.7% | 2205 | 58 | 39% | X |
| #62 | 120 | 1.6 | 550 | 21.8% | 2196 | 55 | 25% | X |
| #63 | 120 | 1.6 | 650 | 18.5% | 2210 | 90 | 9% | X |
| #64 | 120 | 1.6 | 950 | 10.5% | 2215 | 55 | 0% | X |

As indicated in [Table 1] to [Table 3], when the percentage value of the average diameter L_{C} of the core based on the average thickness td of the dielectric layer was 15% or more and 19% or less, and the sum of the average atomic percentage of dysprosium (Dy) in the shell and the average atomic percentage of tin (Sn) in the shell was 0.8 at % or more and 1.2 at % or less, the dielectric constant, MTTF, and the short circuit rate properties were excellent, whereas the percentage value of the average diameter L_{C} of the core based on the average thickness td of the dielectric layer did not satisfy 15% or more and 19% or less, or when the sum of the average atomic percentage of dysprosium (Dy) in the shell and the average atomic percentage of tin (Sn) in the shell did not satisfy 0.8 at % or more and 1.2 at % or less, at least one of the properties of the dielectric constant, MTTF, and the short circuit rate was defective.

Accordingly, when the percentage value of the average diameter L_{C} of the core based on the average thickness td of the dielectric layer was 15% or more and 19% or less, and the sum of the average atomic percentage of dysprosium (Dy) in the shell and the average atomic percentage of tin (Sn) in the shell is 0.8 at % or more and 1.2 at % or less, the dielectric constant and reliability of the multilayer electronic component were both excellent.

According to the aforementioned embodiments, the multilayer electronic component may have improved dielectric constant.

Also, the multilayer electronic component may have improved mean time to failure (MTTF) under harsh conditions.

Also, the multilayer electronic component may have improved reliability.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The suggested embodiments may be implemented do not exclude the possibilities of combination with features of other embodiments. For example, even though the features described in an embodiment are not described in the other embodiment, the description may be understood as relevant to the other embodiment unless otherwise indicated.

Terms used in the present specification are for explaining the embodiments rather than limiting the embodiments. Unless explicitly described to the contrary, a singular form may include a plural form in the present specification

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a dielectric layer and internal electrodes; and
external electrodes disposed on the body,
wherein the dielectric layer includes a plurality of dielectric grains, and at least one of the plurality of dielectric grains has a core-shell structure including a core and a shell surrounding at least a portion of the core,
wherein an average diameter of the core is 15% or more and 19% or less of an average thickness of the dielectric layer, and
wherein the shell includes rare earth elements and tin (Sn), and an average atomic percentage of a sum of the rare earth elements and tin (Sn) included in the shell is 0.8 at % or more and 1.2 at % or less with respect to a total atomic amount of the shell.

2. The multilayer electronic component of claim 1, wherein an average atomic percentage of the rare earth elements included in the shell is 0.2 at % or more and 0.7 at % or less.

3. The multilayer electronic component of claim 1, wherein an average atomic percentage of tin (Sn) included in the shell is 0.2 at % or more and 1.0 at % or less.

4. The multilayer electronic component of claim 1, wherein an average thickness of the dielectric layer is less than 0.8 μm.

5. The multilayer electronic component of claim 1, wherein an average diameter of the core is 70 nm or more and 120 nm or less.

6. The multilayer electronic component of claim 1, wherein an average atomic percentage of the rare earth elements in the core is 0 at % or more and less than 0.2 at %.

7. The multilayer electronic component of claim 1, wherein an average atomic percentage of tin (Sn) in the core is 0 at % or more and less than 0.2 at %.

8. The multilayer electronic component of claim 1, wherein an average atomic percentage of a sum of the rare earth elements and tin (Sn) included in the core is 0 at % or more and less than 0.4 at %.

9. The multilayer electronic component of claim 1, wherein the dielectric layer includes barium titanate (BaTiO₃)-based material as a main component.

10. The multilayer electronic component of claim 1, wherein the rare earth elements include at least one of dysprosium (Dy) or terbium (Tb).

11. The multilayer electronic component of claim 1, wherein an average thickness of the internal electrode is 0.6 μm or less.

12. The multilayer electronic component of claim 1, wherein the multilayer electronic component has a length of 0.6 mm or less and a width of 0.3 mm or less.
